(19) United States
(12) Patent Application Publication
(10) Pub. No.: US 2016/0149711 A1
(43) Pub. Date: May 26, 2016

(54) DISTRIBUTED IDENTIFICATION SYSTEM FOR PEER TO PEER MESSAGE TRANSMISSION

(71) Applicant: WYZR Limited, Dublin (IE)

(72) Inventor: Cathal Fitzgerald, Dublin (IE)

(21) Appl. No.: 14/950,435

(22) Filed: Nov. 24, 2015

Related U.S. Application Data
(60) Provisional application No. 62/083,708, filed on Nov. 24, 2014.

(51) Int. Cl. H04L 9/32; H04L 29/12; H04L 9/08

(52) U.S. Cl. CPC H04L 9/3263; H04L 9/0861; H04L 61/2007

(57) ABSTRACT

The present disclosure describes computer systems and methods for peer to peer information exchange. The methods entail receiving, by a first computer system, a first Internet Protocol (IP) address from a second computer system, generating a first key pair comprising a first public key and a first private key, generating, by the first computer system, a first public key certificate comprising the first public key and the first IP address, and generating a first address-book entry comprising the first public key certificate. The first address-book entry, along with a likewise generated second address-book entry on a third computer system, enable direct communication between the a user on the first computer system and a second user on third computer system, without relying on a domain name server (DNS) or a mnemonic address assignment.

### CROSS REFERENCE TO RELATED APPLICATIONS

This application claims the benefit under 35 U.S.C. §119(e) of U.S. Provisional Application No. 62/083,708, filed on Nov. 24, 2014, which is incorporated by reference in its entirety.

### BACKGROUND

Conventional messaging and social networking systems rely on multiple centralized services for their functioning. Messaging systems, such as electronic mail (email), instant messaging (IM), social network messaging, and financial messaging, utilize a store and forward messaging paradigm whereby a sender transmits a message to a central server which stores it until the message is forwarded to the intended recipient.

Client systems depend on the Domain Name System (DNS) to correctly resolve the domain name of the server into it's Internet Protocol (IP) address in order for senders and receivers to access the service. Further, both central servers and the client systems (e.g., the senders and receivers) rely on Public Key Infrastructures (PKI) to provide proof of identity.

The dependence on central services leads to a number of undesirable vulnerabilities. First, as all messages are handed to a central server, whether encrypted or not, the sender cedes privacy to a great extent in the use of the central service. Here, the message content and/or the message meta-data is open to inspection by the service provider or other parties capable of accessing the central service, legally or otherwise.

Second, a compromise of the supporting PKI, such as in the case in the DigiNotar hacking of 2011, leads to a total compromise of the service. The weakness of the PKI approach is that the authenticity of the certificates issued is only as good as the security of the Certificate Authority (CA). In 2014, researchers still point out that weak cryptographic algorithms and keys lengths are being used by trusted CAs which can easily lead to fake certificates being created for well know services.

The same weakness exists in relation to the DNS. Where a malicious party can either intercept the requests from the sender or falsify a DNS entry, traffic will be redirected to an alternate site. This was the type of attack used by the Syrian Electronic Army in 2013 to redirect the New York Times and Twitter website to sites supporting the Assad regime in Syria.

Finally, the dependence of identity services on other central services and their supporting infrastructures weakens their robustness. Where a server is authenticated by a certificate from a PKI infrastructure using a Domain Name in the certificate as a claim in order to authenticate claims from users leads to a lessening of trust. The systemic risk from this interdependence can, and has lead to catastrophic failures in the protection of communication and privacy.

### SUMMARY

It is herein contemplated that systemic risks during information exchange between different computing devices can be greatly reduced by eliminating dependency and interdependency on central servers and supporting infrastructures. In this context, it is noted that that the DNS, centralized PKI services and the use of central servers for messaging are unnecessary and can present a risk to privacy and security.

The present technology provides a true peer-to-peer communication system which avoids the use of central servers to facilitate establishment of communication channels and the need for de-referencing addressing data in identity credentials and mnemonic user names. In some embodiments, the present technology combines a modified Pretty Good Privacy certificate with Internet Protocol version 6 (IPv6) addressing (including its mobility extensions) such that users can avoid dependence on central servers for communicating and sharing data.

In one embodiment, the present disclosure provides a computing device comprising a memory, a processor, and program code comprising: (a) an initiation module which, when executed by the processor, configures the device to receive a first Internet Protocol (IP) address from an IP address server; generate a first key pair comprising a first public key and a first private key; generate a first public key certificate comprising the first public key and the first IP address; and generate a first address-book entry comprising the first public key certificate; (b) a sharing module which, when executed by the processor, configures the device to share the first address-book entry with a second computing device and receive a second address-book entry from a second computing device that comprises a second IP address of the second computing device; and (c) a communication module which, when executed by the processor, configures the device to transmit a first message to the second computing device and receive a second message from the second computing device, without looking up the second IP address from a remote server.

As used herein, a program code module refers to a collection of one or more functionalities of a software program when executed by a computing device, and is not limited to a particular implementation. Therefore, the modules are not necessarily named as described herein or referred to as a functional unit.

In some aspects, looking up the second IP address from a remote server comprises de-referencing a name of a user of the second computing device using a domain name server (DNS) or a mnemonic address assignment. In other words, the computing devices locate each other on a network with each other's IP addresses, without the need to looking up those IP addresses in a centralized IP address database with, e.g., a user or computer's user name, as the conventional technology requires.

In some aspects, the program code configures the device to receive an IP address block from the IP address server comprising the first IP address, and selecting the first IP address from the block. In some aspects, the program code further configures the device to confirm to the IP address server selection of the first IP address. In some aspects, the selection of the first IP address from the IP address block takes an input from a user, or uses a random number function.

In some aspects, the first address-book entry is shared as a QR code. In some aspects, the address-book entry is in vCard format. In some aspects, the first message is encrypted with the first public key. In some aspects, the first public key certificate comprises the first IP address in a subject field of the public key certificate. In some aspects, the first IP address is an IPv6 address.

In some aspects, the second address-book entry is generated by a method comprising receiving the second IP address from an IP address server; generating a second key pair comprising a second public key and the second private key; generating a second public key certificate comprising the second public key and the second IP address; and generating the second address-book entry comprising the second public key certificate.

In some aspects, the first public key certificate is generated with the first public key by using a Certificate Authority (CA) separate from the computing device. In some aspects, the generation of the first public key certificate comprises providing, by the computing device, the first public key to the CA and receiving the public key certificate generated on the CA using the first public key and signed by the CA.

### BRIEF DESCRIPTION OF THE DRAWINGS

Provided as embodiments of this disclosure are drawings which illustrate by exemplification only, and not limitation, wherein:

FIG. 1 illustrates the process of setting up a personal identification for a computing device, which identification includes a public key certificate that contains a public key and a selected IP address.

It will be recognized that some or all of the figures are schematic representations for exemplification and, hence, that they do not necessarily depict the actual relative sizes or locations of the elements shown.

### DETAILED DESCRIPTION

Digital certificates, whether X.509 or PGP, contain a domain name qualified subject identifier against which they make a claim (i.e. person@some_mailserver.com or www.some_server.com). However, the domain name component is just a mnemonic for an underlying Internet Protocol address which must be obtained after resolving (de-referencing) it against the DNS system.

The present disclosure provides systems, non-transitory computer-readable media, and computer-implemented methods that create public key certificates in which domain names are replaced with Internet Protocol (IP) addresses, such as IPv6 addresses. As such, the present technology avoids the need to resolve the domain names using DNS. Further, the present technology can also allow a user to avoid the reliance on Certificate Authorities (CA), as the certificates used herein, in some embodiments, are self-generated and self-signed.

The certificates generated with the present technology provides an identity mechanism that directly points to a communication partner instead of indirectly via the DNS.

Further, the present technology ensures scalability to an Internet level, by taking advantage of the IPv6 mobility to create unique user identity, reachability and mobility on data networks. Use of IPv6 allows the allocation of permanent unique addresses to the end systems. Additionally the mobility mechanisms in IPv6 allow scaling of mobility to an Internet level without a collapse of the Internet Routing Tables.

### User-Associated Public Key Certificates

The present disclosure provides systems and methods to generate a public key certificate for a user that desires internet communications, such as messaging, or social network communication. The communication typically takes the form of transmission of an electronic message, or simply “message.” A message, as used here, encompasses all forms of electronic data, which can be as large as video files, as complicated as file systems, or as simple as a word, a byte or even a bit of data.

In some embodiments, the communications take place between two instances of an application software program separately installed on two computer systems. On mobile computer systems, such application software programs are typically referred to as “apps.”

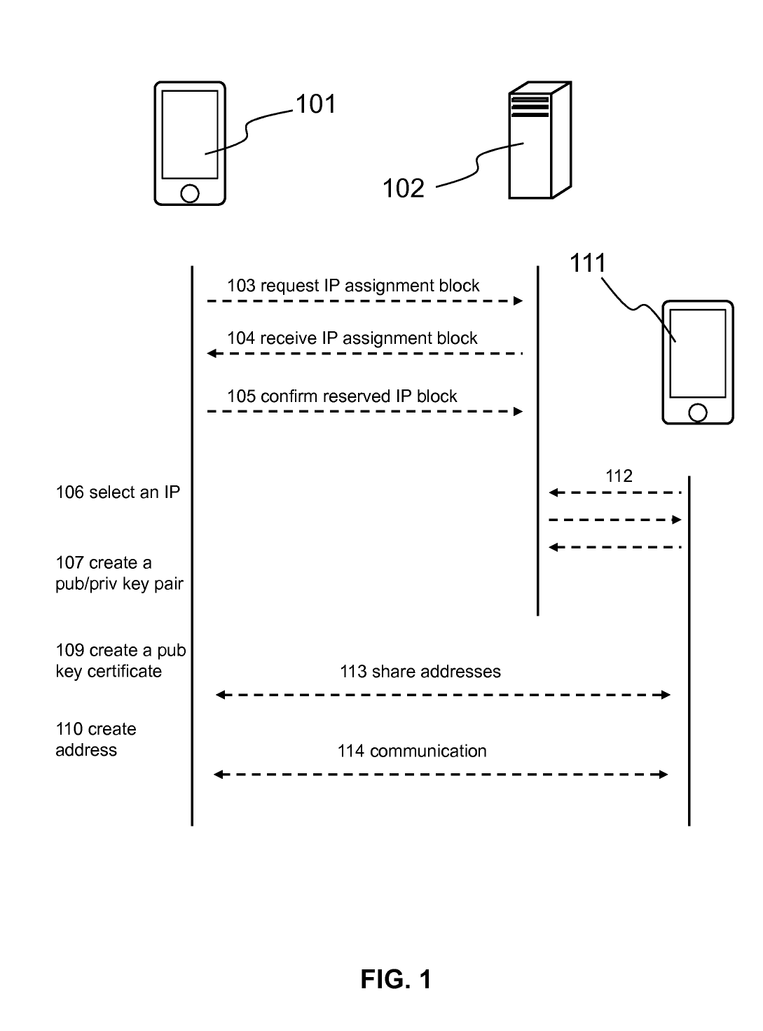

With reference to FIG. 1, to enable such communications, in one embodiment, a user (e.g., at a client computer 101) first sends a request 103 to an enrollment service (e.g., at a server computer 102, also referred to as an IP address server) for allocation of an IP address or a block of IP addresses. In response, the service sends the user an IP address or a block of IP addresses (step 104). In some embodiments, each IP address in the block has not been assigned to another computer device or user, as further detailed below. In one aspect, each IP address is an IPv6 address.

An “IP address block,” as used herein, refers to two or more IP addresses. In one aspect, an IP address block includes two or more consecutive IP addresses. In some aspects, an IP address block includes at least 2, 4, 8, 16, 32, 64, 128, 256, 512, 1024, 2¹¹, 2¹², 2¹³, 2¹⁴, 2¹⁵, or 2¹⁶ IP addresses.

“Internet Protocol version 6” or “IPv6” is the latest version of the Internet Protocol (IP), the communications protocol that provides an identification and location system for computers on networks and routes traffic across the Internet. IPv6 was developed to deal with the long-anticipated problem of IPv4 address exhaustion. IPv6 uses a 128-bit address, allowing 2¹²⁸, or approximately 3.4×10³⁸ addresses, or more than 7.9×10²⁸ times as many as IPv4, which uses 32-bit addresses and provides approximately 4.3 billion addresses. IPv6 addresses are represented as eight groups of four hexadecimal digits separated by colons, for example 2001:0db8:85a3:0042:1000:8a2e:0370:7334.

The client computer receives the proposed IP address or IP address block (step 104). The client computer can then optionally confirm receipt of the IP address or IP address block (step 105), herein referred to as a “reserved IP address,” or “reserved IP address block”, ensuring that the same IP address or address block is not proposed to other users.

If the client computer receives an IP address block or even one or more IP address blocks, the client computer can then select a particular IP address (see step 106) to be associated with and used by the user. Selection of the IP address can use a predefined function or one or more selection criteria, can be made randomly, or can take an input from the user.

At any time, which can be before, during, or after the client computer receives and selects the user IP address, the client computer generates a public/private key pair (step 107) useful for protecting communication cryptographically and asserting identity.

Public-key cryptography, also known as asymmetric cryptography, is a class of cryptographic algorithms which requires two separate keys, one of which is secret (or private) and one of which is public. Although different, the two parts of this key pair are mathematically linked. The public key is used to encrypt plaintext or to verify a digital signature; whereas the private key is used to decrypt ciphertext or to create a digital signature. Public-key cryptography is used as a method of assuring the confidentiality, authenticity and non-repudiation of electronic communications and data storage. Methods of generating public/private key pairs are well known in the art.

The present technology can also use encryption technologies such as Off The Record (OTR) encryption for instant messaging or ZRTP/SRTP for real time voice and video communication, which can replace or supplement the public-key cryptography.

With the IP address and the public key, the client computer can then generate a public key certificate for the user (step 109). In one embodiment, the public key certificate includes just the user's public key and IP address. In some aspects, the user IP address is located in a domain name field of the public key certificate, which is occupied by a domain name in the conventional X.509 or PGP digital certificate. In some embodiments, the client computer sends a copy of the public key to a key-server, allowing unknown users to access the public key in order to send encrypted communications to the user.

It is noted that, in some aspects, the public key certificate does not include a Uniform Resource Locator (URL) or a Uniform Resource Identifier (URI) in the standard mnemonic DNS form as, in the present technology, direct use is made of the IP addresses in the certificate.

The user's public key certificate thus generated can enable the user to exchange messages with another user that uses another client computer, which has likewise generated a user public certificate (as illustrated in steps 112). In some embodiments, both client computers received proposed IP addresses or IP address blocks from the same enrollment server. In some embodiments, they received the proposed IP address or IP address blocks from different servers, whereas the different servers have mechanisms in place to ensure that different client computers do not select the same user IP address. For instance, the two servers have communication with regard to what IP address/IP address blocks each client computer selected. In another example, each server is allocated different IP addresses so that they cannot propose the same IP address or IP address blocks to their corresponding client computers.

In general, the user's public key certificate can be generated on the client computer. In some aspects, nevertheless, a Certificate Authority (CA) server can be used to assist the generation. In this respect, the client computer sends the user's public key and the user IP address to the CA server, which then generates a user public key certificate for the user and sends the certificate back to the client computer.

A client computer is not limited to use by a single user, it is noted. When a second user sets up the client computer for his/her own use, the client computer can quickly select another IP address from the reserved IP address block for this new user, for instance. In some aspects, the earlier user may desire to change his/her IP address. In that respect, a different IP address from the reserved IP address block can be chosen. Nevertheless, in either instance, the client computer can also request a new IP address block from an enrollment service.

For the users' convenience, in some embodiments, the client computer creates an address-book entry for the user that includes the user's public key certificate (step 110). An “address-book entry” generally refers to a data set that stores a public key certificate of a user, optionally along with other information of the user that the user would like to share with other users. Examples of such additional information include, without limitation, name, phone number, avatar, social networking profile identification, and email address. In some embodiments, the address-book entry takes the form of a vCard, which is well known in the art.

An address-book entry can be transmitted and thus shared (step 113) electronically, such as through wired or wireless internet connection, or near field communication. In some embodiments, the user can upload the public key certificate to a central database, such that it can be searched and downloaded by another user. In some embodiments, either an identification or reference number of the user's public key certificate or the certificate itself can be embedded in a graphic code, such as a QR code. When a user intends to share the user's public key certificate with another user, the user can simply display or send the QR code to the other user.

Peer-to-Peer Communication with Users' Public Key Certificates

Once two users have each other's public key certificates, they can start to exchange electronic messages step 114), such as conducting instant messaging, online audio/video chatting, or asynchronous messaging (analogous to e-mail). The public keys and IP addresses in the users' public key certificate play important role in enabling such communication while keeping the communication highly secure and private.

To send a message to a second user, a first user (sender) encrypts the message with the second user (recipient)'s public key and routes the message to the recipient's device using the recipient's IP address. As such, the message does not need to go through a central server or rely on CAs or DNS.

Further, as the message is encrypted by the recipient's public key, the message can only be decrypted with the recipient's private key. Since only the recipient has access to the private key, and there is no store-and-forward mechanism involved in transmitting the message (i.e. the message is never received and stored by an intermediary server) it is highly unlikely anyone other than the recipient will receive and decrypt the message successfully.

Therefore, compared to the conventional electronic communication technologies, the present IP address-based, distributed user identification and communication technology provides the highest privacy and security to internet users.

### Computer Systems and Network

The methodology described here can be implemented on a computer system or network. A suitable computer system can include at least a processor and memory; optionally, a computer-readable medium that stores computer code for execution by the processor. Once the code is executed, the computer system carries out the described methodology.

In this regard, a “processor” is an electronic circuit that can execute computer programs. Suitable processors are exemplified by but are not limited to central processing units, microprocessors, graphics processing units, physics processing units, digital signal processors, network processors, front end processors, coprocessors, data processors and audio processors. The term “memory” connotes an electrical device that stores data for retrieval. In one aspect, therefore, a suitable memory is a computer unit that preserves data and assists computation. More generally, suitable methods and devices for providing the requisite network data transmission are known.

Also contemplated is a non-transitory computer readable medium that includes executable code for carrying out the described methodology. In certain embodiments, the medium further contains data or databases needed for such methodology.

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above also come within the scope of “machine-readable media.” Machine-executable instructions comprise, for example, instructions and data that cause a general purpose computer, special-purpose computer or special-purpose processing machine(s) to perform a certain function or group of functions.

Embodiments of the present disclosure have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present disclosure may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the disclosure also may be practiced in distributed and cloud computing environments where tasks are performed by local and remote processing devices that are linked, by hardwired links, by wireless links or by a combination of hardwired or wireless links, through a communications network. In a distributed computing environment, program modules may be located in both local and remote memory storage devices.

Although the discussions above may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure. Such variations will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this disclosure belongs.

The disclosures illustratively described herein may suitably be practiced in the absence of any element or elements, limitation or limitations, not specifically disclosed here. For example, the terms “comprising”, “including,” containing,” etc. shall be read expansively and without limitation. Additionally, the terms and expressions employed here have been used as terms of description and not of limitation; hence, the use of such terms and expressions does not evidence and intention to exclude any equivalents of the features shown and described or of portions thereof. Rather, it is recognized that various modifications are possible within the scope of the disclosure claimed.

By the same token, while the present disclosure has been specifically disclosed by preferred embodiments and optional features, the knowledgeable reader will apprehend modification, improvement and variation of the subject matter embodied here. These modifications, improvements and variations are considered within the scope of the disclosure.

The disclosure has been described broadly and generically here. Each of the narrower species and subgeneric groupings falling within the generic disclosure also form part of the disclosure. This includes the generic description of the disclosure with a proviso or negative limitation removing any subject matter from the genus, regardless of whether or not the excised material is described specifically.

Where features or aspects of the disclosure are described by reference to a Markush group, the disclosure also is described thereby in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

Although the disclosure has been described in conjunction with the above-mentioned embodiments, the foregoing description and examples are intended to illustrate and not limit the scope of the disclosure. Other aspects, advantages and modifications within the scope of the disclosure will be apparent to those skilled in the art to which the disclosure pertains.

1. A computing device comprising a memory, a processor, and program code comprising:
(a) an initiation module which, when executed by the processor, configures the device to receive a first Internet Protocol (IP) address from an IP address server; generate a first key pair comprising a first public key and a first private key; generate a first public key certificate comprising the first public key and the first IP address; and generate a first address-book entry comprising the first public key certificate;
(b) a sharing module which, when executed by the processor, configures the device to share the first address-book entry with a second computing device and receive a second address-book entry from a second computing device that comprises a second IP address of the second computing device; and
(c) a communication module which, when executed by the processor, configures the device to transmit a first message to the second computing device and receive a second message from the second computing device, without looking up the second IP address from a remote server.

2. The computing device of claim 1, wherein looking up the second IP address from a remote server comprises de-referencing a name of a user of the second computing device using a domain name server (DNS) or a mnemonic address assignment.

3. The computing device of claim 1, wherein the program code configures the device to receive an IP address block from the IP address server comprising the first IP address, and selecting the first IP address from the block.

4. The computing device of claim 3, wherein the program code further configures the device to confirm to the IP address server selection of the first IP address.

5. The computing device of claim 3, wherein the selection of the first IP address from the IP address block takes an input from a user, or uses a random number function.

6. The computing device of claim 1, wherein the first address-book entry is shared as a QR code.

7. The computing device of claim 1, wherein the second address-book entry is generated by a method comprising receiving the second IP address from an IP address server; generating a second key pair comprising a second public key and the second private key; generating a second public key certificate comprising the second public key and the second IP address; and generating the second address-book entry comprising the second public key certificate.

8. The computing device of claim 1, wherein the first message is encrypted with the first public key.

9. The computing device of claim 1, wherein the first public key certificate comprises the first IP address in a subject field of the public key certificate.

10. The computing device of claim 1, wherein the address-book entry is in vCard format.

11. The computing device of claim 1, wherein the first public key certificate is generated with the first public key by using a Certificate Authority (CA) separate from the computing device.

12. The computing device of claim 11, wherein the generation of the first public key certificate comprises providing, by the computing device, the first public key to the CA and receiving the public key certificate generated on the CA using the first public key and signed by the CA.

13. The computing device of claim 1, wherein the first IP address is an IPv6 address.

14. A non-transitory computer-readable medium comprising program code comprising:
(a) an initiation module which, when executed by the processor, configures the device to receive a first Internet Protocol (IP) address from an IP address server; generate a first key pair comprising a first public key and a first private key; generate a first public key certificate comprising the first public key and the first IP address; and generate a first address-book entry comprising the first public key certificate;
(b) a sharing module which, when executed by the processor, configures the device to share the first address-book entry with a second computing device and receive a second address-book entry from a second computing device that comprises a second IP address of the second computing device; and
(c) a communication module which, when executed by the processor, configures the device to transmit a first message to the second computing device and receive a second message from the second computing device, without looking up the second IP address from a remote server.
